(19) United States
(12) Patent Application Publication
(10) Pub. No.: US 2020/0164576 A1
(43) Pub. Date: May 28, 2020

(54) APPARATUS FOR ADDITIVE MANUFACTURING AND PROCESS FOR ADDITIVE MANUFACTURING

(71) Applicant: 3D NEW TECHNOLOGIES S.R.L., Rovereto (TN) (IT)

(72) Inventor: Fabio FERRARIO, Berlin (DE)

(21) Appl. No.: 16/064,945

(22) PCT Filed: Dec. 19, 2016
(86) PCT No.: PCT/IB2016/057779

§ 371 Date: Jun. 21, 2018

(30) Foreign Application Priority Data
Dec. 22, 2015 (IT) 102015000086238

(51) Int. Cl. B29C 64/214; B29C 64/153; B22F 3/105; B28B 1/00; B33Y 10/00; B33Y 30/00

(52) U.S. Cl. CPC B29C 64/214; B29C 64/153; B22F 3/1055; B22F 2003/1056; B33Y 10/00; B33Y 30/00; B28B 1/001

(57) ABSTRACT

An apparatus for additive manufacturing includes a platform adapted to receive a powder bed laid thereon; two support columns vertically fastened to opposite sides of the platform; a cross member transversally fastened between the columns; a device based on a laser-diode laser source, fixed to the cross member and adapted to emit a laser beam towards the powder bed; a doctor blade transversally fastened to the basis of the columns, the columns being adapted to slide along the sides, thus dragging the doctor blade on the powder bed; wherein the doctor blade slides in a direction opposite to the direction in which the laser beam is emitted by the device.

### BACKGROUND OF THE INVENTION

### 1. The Field of the Invention

The present invention relates to an apparatus for additive manufacturing and to a method for using said apparatus in order to implement an additive manufacturing process.

### 2. The Relevant Technology

The term additive manufacturing relates to a process wherein three-dimensional design data are used for fabricating a component by progressively depositing multiple layers of material. Additive manufacturing is a professional production technique clearly different from all conventional material removal methods: instead of producing a semifinished product by starting from a solid block, components are built layer by layer starting from material available as a thin powder. Many different types of materials can be used, particularly metals, plastics or composite components.

The process starts with the deposition of a thin layer of powder material onto a manufacturing platform (bed). A laser beam is then used to melt the powder exactly in predefined locations according to the component's design data. The platform is then lowered, a subsequent layer of powder is applied, and the material is melted again so that it will bind to the underlying layer in predefined locations.

FIG. 1 shows an apparatus for additive manufacturing 1 according to the prior art.

Said apparatus comprises a laser source, associated optics for laser beam transmission and scanner optics, designated as a whole by reference numeral 2, which are adapted to emit a laser beam 4 directed towards a powder bed 6.

The powder bed 6 is fed by a powder dispenser piston 6a, which feeds the powder, in a supply area 7, onto the platform 6b. The dispenser piston 6a moves vertically upwards in a direction A as the powder is used.

A doctor blade 8 moves transversally relative to the platform 6b in a direction B parallel to the plane in which the powder bed 6 lies, thereby moving the powder from the supply area 7 towards a work area 10 in which the laser beam 4 progressively manufactures a product 12 by sintering (laser melting) the layer of powder just deposited by the doctor blade 8. A platform 6b′ is also present in the work area 10, whereon the powder brought by the doctor blade 8 is deposited, and a support piston 6a′ moves vertically downwards in a direction C as the product 12 is formed and grows.

In the work area 10, an emission outlet and a suction inlet (not shown in the drawing) are advantageously present, which are disposed transversally relative to the powder bed 6 and parallel to the plane in which the powder bed lies, and which are respectively adapted to produce a blade of a predetermined gas, e.g., argon, and to suck it in. The gas is used for cleaning the work area 10 from the vapours produced by powder sublimation; such vapours must not, in fact, re-condense on the product 12, since they would otherwise create manufacturing defects.

The apparatus of FIG. 1 is a static system that cannot easily grow in size for manufacturing large parts; as the dimensions of the product 12 increase, the size of the emission outlet and of the suction inlet should increase as well, but, if the emitted air blade is too large, the air will produce turbulences on the surface of the powder bed 6 that will not allow for optimal processing, since they will impair the uniformity and homogeneity of the powder bed 6.

Moreover, in the apparatus of FIG. 1, because the laser source 2 is in a fixed position, it is necessary that the doctor blade 8 completes the deposition of the powder bed 6 onto the platform 6b′ before the source 2 can be activated and production of the product 12 can start. Therefore, there are many intervals between one processing step and the next, which limit the productivity of the system in that it is necessary to wait for a new powder bed to be laid before starting a new processing cycle.

Likewise, a damaged component will cause a long downtime.

### SUMMARY OF THE INVENTION

It is therefore an object of the present invention to propose an apparatus for additive manufacturing which allows eliminating the air turbulences that develop when large products are manufactured, and which offers increased productivity.

Embodiments of the present invention concern an apparatus for additive manufacturing and a method of additive manufacturing which can overcome the drawbacks of the prior art.

In one embodiment, the apparatus for additive manufacturing comprises a platform adapted to receive a powder bed laid thereon; two support columns vertically fastened to opposite sides of said platform; a cross member transversally fastened between the columns; a device based on a laser-diode laser source, fixed to said cross member and adapted to emit a laser beam towards the powder bed; a doctor blade transversally fastened to the bases of the columns, the columns being adapted to slide along said sides, thus dragging the doctor blade on the powder bed; wherein the doctor blade slides in a direction opposite to the direction in which the laser beam is emitted by the device.

In another embodiment, the platform is supported by a piston adapted to move vertically.

In another embodiment, the cross member is adapted to slide vertically along guides of the columns.

In another embodiment, a suction inlet is secured to the doctor blade for sucking in the powder sublimation vapours as the laser beam creates a product on the powder bed.

In another embodiment, a control unit controls the movements of the columns.

In another embodiment, the device based on a laser-diode laser source comprises an electronic control unit adapted to receive an input signal representative of a manufacturing target of a product to be fabricated and to send a first control signal towards a light source in order to control the power thereof, the light source emitting a laser beam towards a laser scanner adapted to focus said laser beam towards a powder bed from which the product is obtained.

In another embodiment, a method of additive manufacturing comprises the steps of providing an apparatus for additive manufacturing comprising a platform adapted to receive a powder bed laid thereon; two support columns vertically fastened to opposite sides of said platform; a cross member transversally fastened between the columns; a device based on a laser-diode laser source, fixed to said cross member and adapted to emit a laser beam towards the powder bed; a doctor blade transversally fastened to the basis of the columns, the columns being adapted to slide along said sides, thus dragging the doctor blade on the powder bed; wherein the doctor blade slides in a direction opposite to the direction in which the laser beam is emitted by the device; dragging the doctor blade horizontally on the powder bed by causing the columns to slide along the sides of the platform up to a terminal transversal edge of said platform; turning the laser-diode device about a longitudinal axis of the cross member; dragging the doctor blade horizontally on the powder bed in the direction opposite to the previous one.

### BRIEF DESCRIPTION OF THE DRAWINGS

Further features and advantages of the invention will become apparent in the light of the following detailed description, provided by way of non-limiting example with reference to the annexed drawings, wherein:

FIG. 1, as already described, shows an apparatus for additive manufacturing according to the prior art;

FIG. 2 shows an apparatus for additive manufacturing according to the present invention; and

FIG. 3 shows a laser-diode device used in an apparatus for additive manufacturing according to the present invention.

### DETAILED DESCRIPTION OF THE PREFERRED EMBODIMENTS

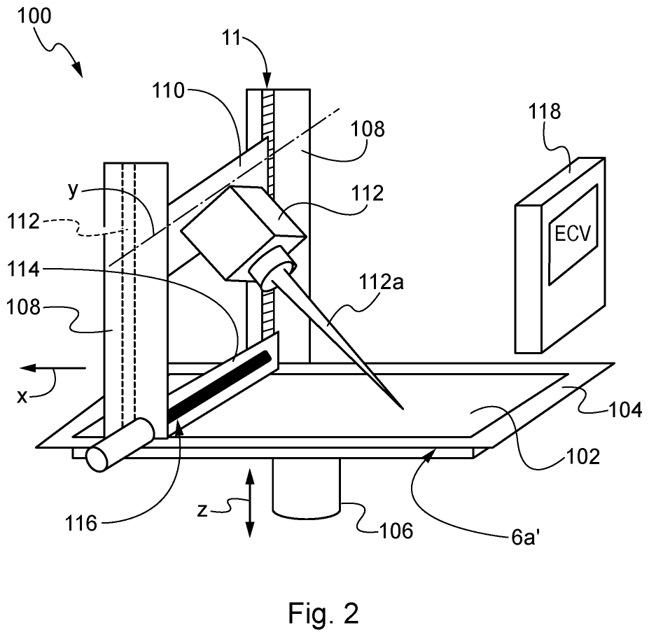

FIG. 2 shows an apparatus 100 for additive manufacturing according to the present invention.

It comprises a powder bed 102 laid horizontally on a platform 104, preferably rectangular in shape, supported by a piston 106 adapted to move vertically in a per se known manner along a vertical direction Z, so as to move said platform 104 along the direction Z.

Two support columns 108 are vertically fastened to opposite sides of said platform 104, respectively.

A cross member 110 is slidably fastened between the two columns 108, said cross member 110 being adapted to slide vertically along vertical guides 112 of the columns 108. Alternatively, said cross member 110 is in a fixed position.

A device based on a laser-diode source 112 (described in detail below) is fixed to said cross member 110 and is adapted to emit a laser beam 112a towards the powder bed 102.

A doctor blade 14 is transversally fastened to the basis of the columns 108. The columns 108 are adapted to slide along the sides of the platform 104, to which they are secured, in a sliding direction X, thus dragging the doctor blade 114, which lays the powder onto the powder bed 102. The sliding direction X is opposite to the direction in which the laser beam 112a is emitted by the laser device 112.

When the columns 108 arrive at one of the two terminal transversal edges of the platform 104, they start sliding again in the opposite direction, while at the same time the cross member 110 turns with the laser device 112, in a manner known to those skilled in the art, about a longitudinal axis Y of the cross member 110, so that the laser beam 112a will be emitted again in the direction opposite to the direction of travel of the doctor blade 114.

The method of additive manufacturing according to the present invention is therefore based on the use of the apparatus 100, and therefore it comprises the steps of:

dragging the doctor blade 114 horizontally on the powder bed 102 by causing the columns 108 to slide along the sides of the platform 104 up to a terminal transversal edge of said platform 104;

turning the laser-diode device 112 about an axis of the cross member 110;

dragging the doctor blade 114 horizontally on the powder bed 102 in the direction opposite to the previous one.

A suction inlet (blade) 116 is secured to the doctor blade 114 for sucking in the powder sublimation vapours as the laser beam 112a creates a product on the powder bed 102.

A control unit 118 is connected to the apparatus 100 for controlling the movements of the columns and of the laser device 112 and for managing the operation of the apparatus 100.

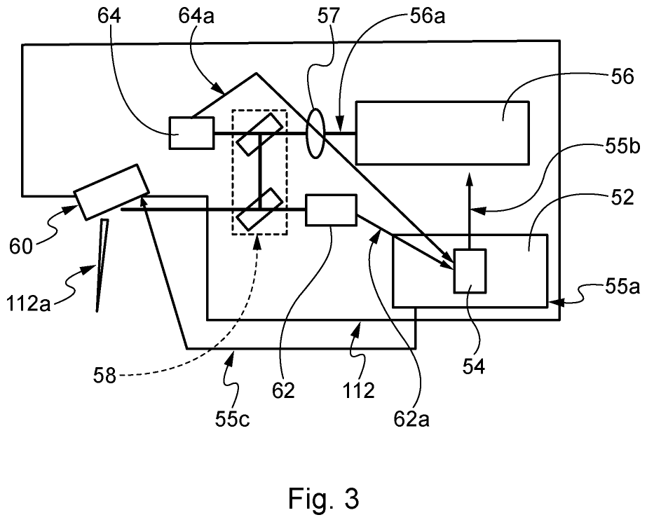

FIG. 3 shows a diagram of the device based on a (high-brilliance) diode-type laser source for additive manufacturing 112 used in the apparatus of FIG. 2.

This device 112 comprises an electronic control unit 52 comprising, in a per se known manner, memory means 54, which unit is adapted to receive an input signal 55a and to send a first control signal 55b to a light source 56, preferably a high-power laser diode.

The input signal 55a is a numerical control signal representative of a desired manufacturing target (laser power, scanning speed, geometry of the part to be fabricated, manufacturing path, etc.), and comes from the control unit 118 of the apparatus 100.

The first control signal 55b is a signal adapted to control the power of the light source 56 on the basis of a desired power value included in the input signal 55a.

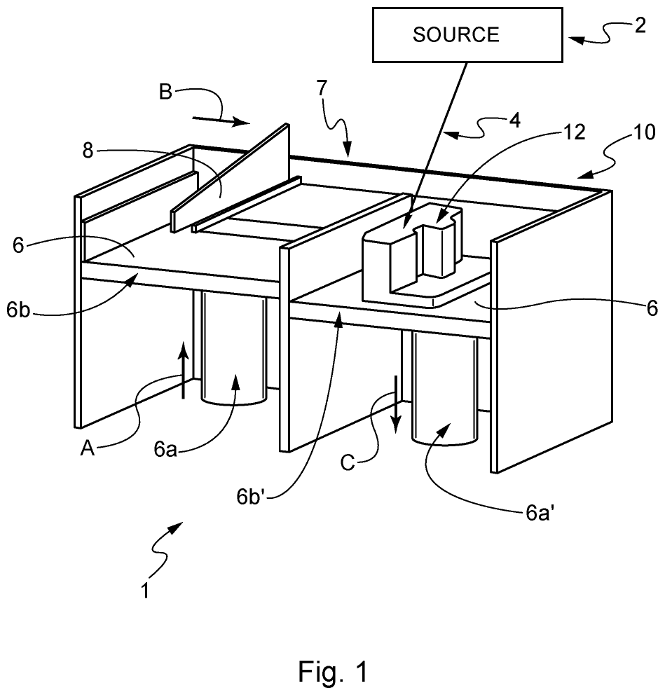

The light source 56 is adapted to emit an internal laser beam 56a, which crosses lenses 57, which adjust the quality thereof, and is then reflected through two dichroic mirrors 58 and finally sent to a laser scanner 60 adapted to focus the output laser beam 112a towards the powder bed 102 of FIG. 1.

The laser scanner 60 moves the laser beam 112a over the powder bed 102 according to position and scanning speed parameters (which depend on the desired manufacturing target as expressed by the input signal 55a) received from the control unit 52 through a second control signal 55c and determined in a manner known to those skilled in the art on the basis of the input signal 55a.

The device based on a diode-type laser source 50 further comprises a dimension sensor 62, preferably a CMOS or ToF sensor, for controlling the dimension of the melted pool created by the laser beam 112a in the powder bed 102 during the process, and a pyrometer or photodiode 64 for controlling in real time the temperature of said powder bed 102. The sensor 62 and the pyrometer 64 are adapted to measure the shape and the temperature, respectively, of the melted pool at predefined time intervals, e.g., every 100 μs, and to send in real time respective measurement signals 62a and 64a to the control unit 52, which in turn will modify the first control signal 55b in order to obtain a modified internal laser beam 56a.

The sensors 62 and 64 are inputted a reflected beam 56b coming from the melted pool, which goes back through the scanner 60 after the manufacturing process and which has a wavelength (e.g., 200-600 nm) which is different from the wavelength of the initial internal laser beam 56a (e.g., 1056 nm). The use of dichroic mirrors 58 allows the internal laser beam 56a (e.g., 1096 nm) to be completely reflected towards the scanner 60, while the reflected beam 56b going back from the melted pool (e.g., 300-600 nm) is completely transferred to and analyzed by the sensors 62 and 64.

The dichroic mirrors 58 are transparent to the radiation that goes back after the process, while they completely reflect the radiation of the internal laser beam 56a, which is useful for the manufacturing process.

In particular, the control unit 52 is adapted to analyze the measurement signals 62a and 64a and for requesting the source 56 to provide a new power output, so as to obtain in real time the desired temperature of the powder bed 102. The desired temperature depends on the desired manufacturing target.

The device 50 allows to provide a feedback control in real time over the temperature and dimensions of the melted pool in the powder bed 102 while processing the powder bed 102, because the sensors 62 and 64 are located in proximity to both the laser 52 and the laser scanner 60.

The solution of the present invention is both compact and economical, while also being flexible to use and providing real-time closed loop control.

As an alternative, in the apparatus 1 any other laser device may be used which is adapted to emit a beam 112a directed towards the powder bed 102.

The apparatus of the present invention has a modular architecture. Thanks to the use of a compact device based on a diode-type laser source 112 that includes the whole source/monitor/scanner part, a machine architecture with columns and cross members (portal architecture) can be obtained.

The portal can be sized according to the dimensions of the desired powder bed 102.

The suction inlet 116 is included in the doctor blade 114, so that suction will always be provided where processing is taking place (suction optimization); this is useful for limiting the formation of air turbulences when large products are being manufactured.

The apparatus of the present invention eliminates the downtimes of the fabrication process, leading to increased productivity: while the doctor blade 114 is laying the powder bed 102, the laser device 112 can be activated in order to start manufacturing the product.

Further (laser) devices can also be integrated for pre-heating and post-heating the powder bed 102 (assisted cooling, useful to improve the properties of the material).

The suction system close to the process optimizes the latter.

Pre-heating and post-heating devices can be easily added.

In one variant of the invention, a plurality of parallel laser devices 112 are fixed to the cross member, so that large components can be manufactured by simultaneously processing the powder bed 102 in different locations.

The dimensions of the suction blade do not contribute to creating turbulences, because the suction inlet 116 moves along with the doctor blade 114 and processing occurs as the powder bed 102 is laid.

Of course, without prejudice to the principle of the invention, the embodiments and the implementation details may be extensively varied from those described and illustrated herein by way of non-limiting example, without however departing from the protection scope of the present invention as set out in the appended claims.

1. An apparatus for additive manufacturing, comprising:
a platform adapted to receive a powder bed laid thereon;
two support columns vertically fastened to opposite sides of said platform;
a cross member transversally fastened between the columns;
a device based on a laser-diode laser source, fixed to said cross member and adapted to emit a laser beam towards the powder bed;
a doctor blade transversally fastened to the basis of the columns, said columns being adapted to slide along said sides, thus dragging the doctor blade on the powder bed;
wherein the doctor blade slides in a direction opposite to the direction in which the laser beam is emitted by the device.

2. The apparatus according to claim 2, wherein the platform is supported by a piston adapted to move vertically.

3. The apparatus according to claim 1, wherein said cross member is adapted to slide vertically along guides of the columns.

4. The apparatus according to claim 1, further comprising a suction inlet secured to the doctor blade for sucking in the powder sublimation vapours as the laser beam creates a product on the powder bed.

5. The apparatus according to claim 1, further comprising a control unit adapted to control the movements of the columns.

6. The apparatus according to claim 1, wherein the device based on a laser-diode laser source comprises:
an electronic control unit adapted to receive an input signal representative of a manufacturing target of a product to be fabricated and to send a first control signal towards a light source in order to control the power thereof, said light source emitting a laser beam towards a laser scanner adapted to focus said laser beam towards a powder bed from which the product is obtained.

7. A method of additive manufacturing, comprising the steps of:
providing an apparatus according to claim 1;
dragging the doctor blade horizontally on the powder bed by causing the columns to slide along the sides of the platform up to a terminal transversal edge of said platform;
turning the laser-diode device about a longitudinal axis of the cross member;
dragging the doctor blade horizontally on the powder bed in the direction opposite to the previous one.
